(19) United States
(12) Patent Application Publication
(10) Pub. No.: US 2010/0178407 A1
(43) Pub. Date: Jul. 15, 2010

(54) OVEN AND METHOD FOR COOKING WITH DRY HEAT AND STEAM HEAT

(76) Inventors: LEANDRO P. RIZZUTO, Sheridan, WY (US); Gary W. Johnson, Norwalk, CT (US); Vincent J. Cefalu, Sea Cliff, NY (US); Asik Braginsky, Forest Hills, NY (US)

Correspondence Address: Lawrence Cruz;Conair Corporation, One Cummings Point Road, STAMFORD, CT, 06902, US

(21) Appl. No.: 12/647,663

(22) Filed: Dec. 28, 2009

Related U.S. Application Data
(60) Provisional application No. 61/141,747, filed on Dec. 31, 2008.

(51) Int. Cl. A23L 1/01; A47J 27/04; A21B 1/22

(52) U.S. Cl. 426/510; 99/473; 219/401

(57) ABSTRACT

An oven 1 includes a housing 2 and a hinged cover 3 arranged to be selectively opened and closed. One or more dials 5, buttons 6, and arrow buttons 7 control various functions including activating heat from either the dry heater 10 or the steam heater 12, controlling temperature settings, setting automatic timers, setting displays, setting alarms, and other functions. A circuit or control is used to cycle off the dry heat element 10 when the steam generator 12 requires power to generate steam and to turn the dry heat element 10 back on when the steam generator 12 has cycled off and steam is being introduced into the chamber of the oven 1.

### CROSS-REFERENCE TO RELATED APPLICATIONS

This application is related to and claims priority from U.S. Provisional Application 61/141,747 filed on 31 Dec. 2008.

### BACKGROUND OF THE INVENTION

The present invention relates to cooking appliances and, more particularly, to countertop oven appliances.

### Description of Related Art

Various countertop oven appliances exist such as toaster ovens and microwave ovens. Toaster ovens use electrically powered heat elements to emit heat within an enclosed volume to heat food placed therein. Microwave ovens use microwaves to heat food on a molecular level. Each has advantages and disadvantages, depending on the type of food being cooked and the objectives of the user. In some instances, microwave ovens cook food faster but fail to brown or crisp the exterior of the food while a toaster oven will do so. On the other hand, a toaster oven, in some instances, will cause food to be dry, particularly on the inside if, for example, the food is a piece of meat. Toaster ovens also typically require more time for cooking than microwave ovens.

Steam cooking ovens exist such as, for example, the Healsio® by Sharp®, which is an oven that cooks by using superheated steam. A water reservoir and heater are used to generate steam, initially, at 100° C. The steam is then heated, under normal pressure, to higher temperatures up to 300° C. (“superheated”) so that droplets of steam contacting the food in the oven will transfer the heat to the food. This type of cooking is fast and is designed to cause fat and salt to drip out of the food. By being limited solely to superheated steam cooking, this product requires relatively high energy and associated energy costs, as well as large volume for the water reservoir required to produce the steam continuously.

It is desirable to provide an oven that overcomes the shortcomings of the oven systems mentioned above while achieving similar benefits of each system mentioned above.

### OBJECT OF THE PRESENT INVENTION

It is an object of the present invention to provide an oven and associated method of use that combines heat elements for producing dry heat in addition to steam generating elements for producing steam heat in order to cook food using both sources of heat simultaneously.

These an other objects are achieved by the present invention disclosed herein.

### SUMMARY OF THE INVENTION

According to the present invention, an oven housing contains the dry heating components and controls of a conventional toaster oven, and additionally contains steam generating components and controls. The oven may cook food using the dry heating components in known methods such as bake, broil and toast, or the oven may implement steam cooking in addition to one of the aforementioned methods or independently of them. By using both dry heat and steam heat, overall cooking times may be reduced. Also, certain foods, such as boneless chicken breasts, may be cooked without drying out, as the steam maintains moisture inside and out during cooking. Due to regulatory and practical considerations, it is necessary to design the oven to utilize adequate electrical power without exceeding electrical power limits. As a practical consideration, relatively high amounts of power are needed to drive either dry heat or steam heat to reach useful heat levels and, therefore, a system for cycling them and regulating their levels is utilized.

### BRIEF DESCRIPTION OF THE DRAWINGS

FIG. 1 is a schematic, perspective view of a preferred embodiment of the present invention.

FIG. 2 is a schematic, side view of a preferred embodiment of the present invention.

FIG. 3 is a schematic, side view of a preferred embodiment of the present invention.

FIG. 4 is a schematic, side view of a preferred embodiment of the present invention.

FIG. 5 is a schematic, front view of a preferred embodiment of the present invention.

FIG. 6 is a schematic, side view of a preferred embodiment of the present invention.

### DESCRIPTION OF THE PREFERRED EMBODIMENT OF THE PRESENT INVENTION

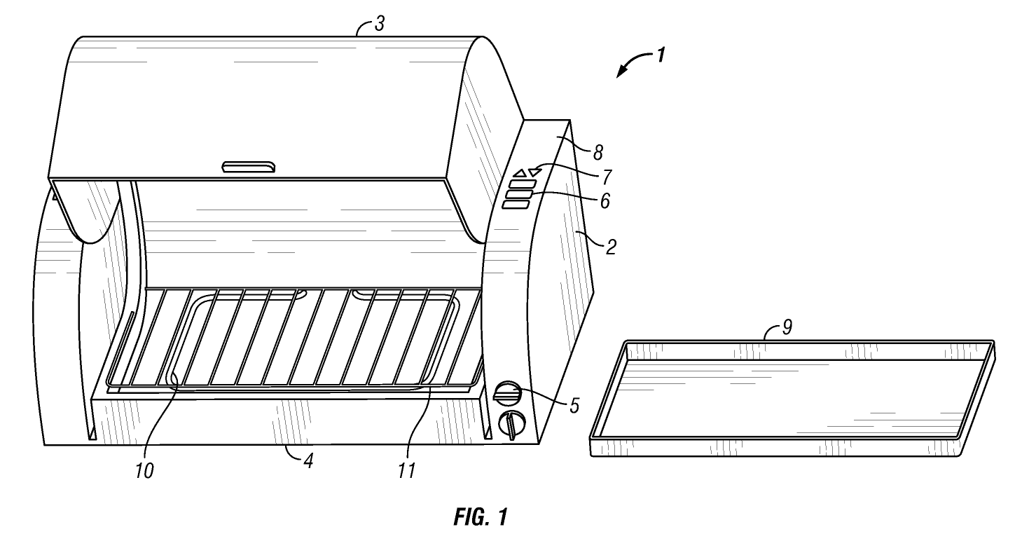

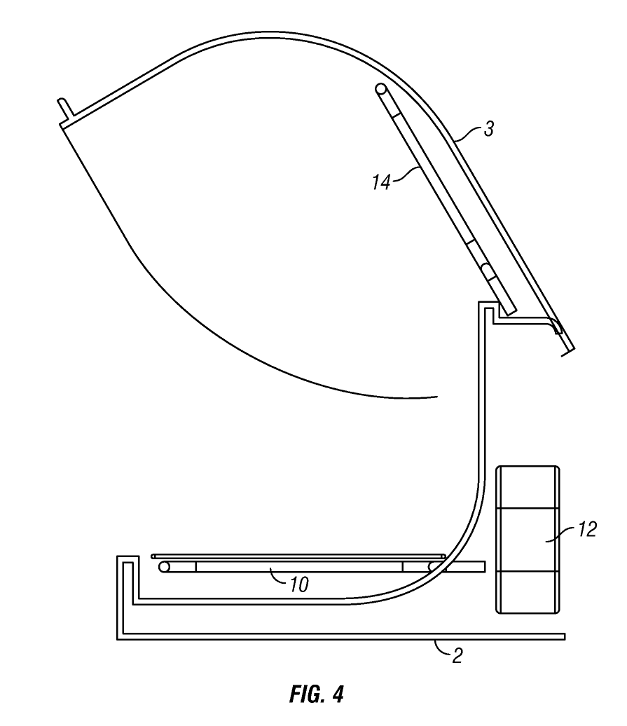

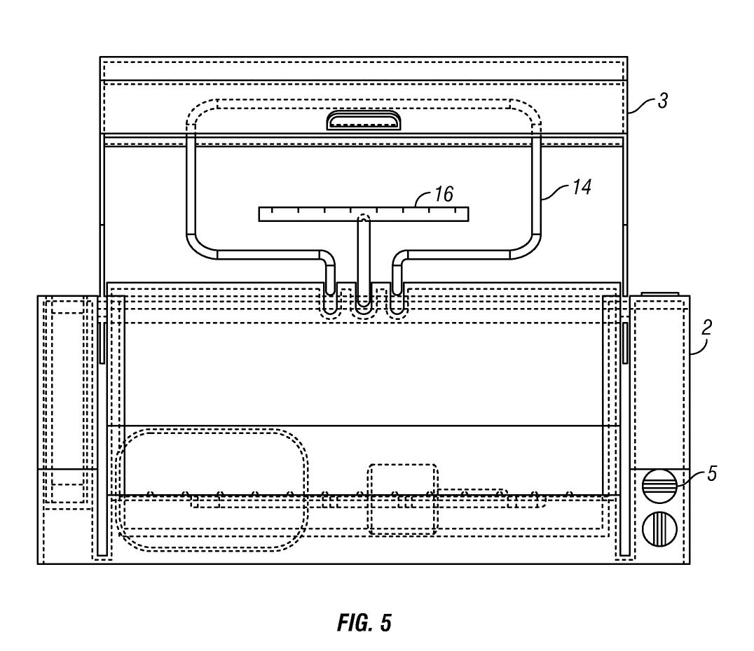

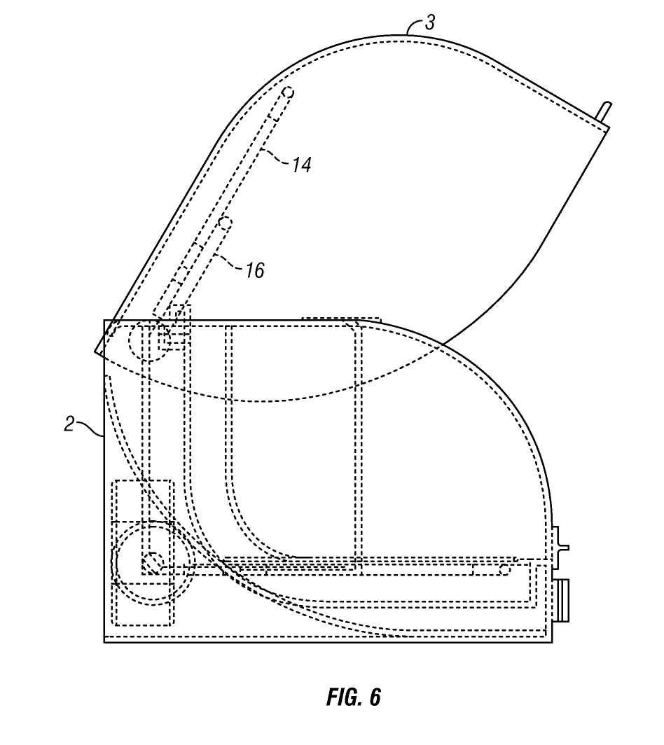

Referring to FIGS. 1-6, an oven 1 includes a housing 2 and a hinged cover 3 arranged to be selectively opened and closed. The opened position is shown in FIG. 1. The front side 4 and top side 8 of the oven 1 include one or more dials 5, buttons 6, and arrow buttons 7 to control various functions including activating heat from either the dry heater or the steam heater, controlling temperature settings, setting automatic timers, setting displays, setting alarms, and other functions. The dry heat element 10 comprises any one or more of known elements used in electric toaster ovens and electric mini ovens and broilers. An over rack 11 may be placed over the heat element 10. A removable grill plate 9 is optional and my be used by placing it over the dry heat elements.

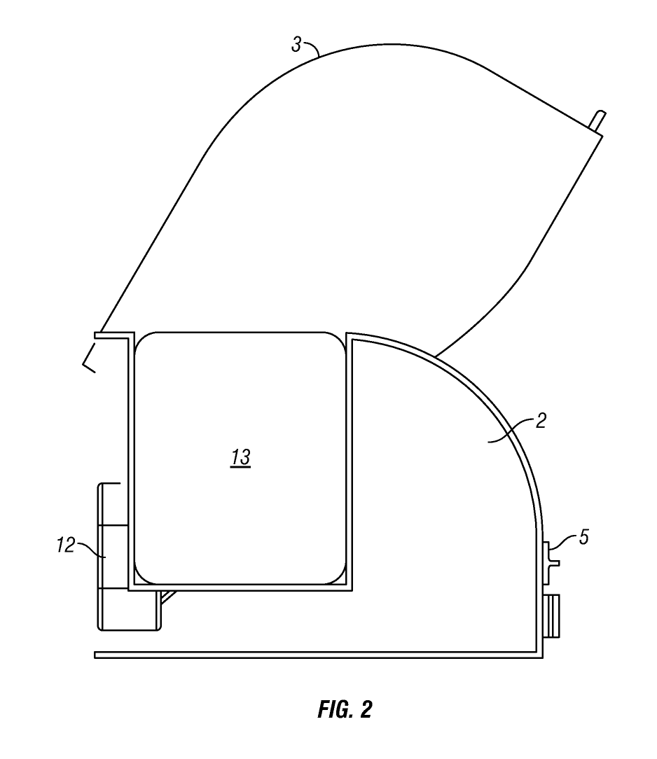

Referring to FIG. 2, a steam generator 12 uses electrical energy to produce steam. It utilizes approximately 1000 watts. By comparison, a standard toaster oven uses approximately 1300-1500 watts to function well. In accordance with the present invention, a circuit or control is used to cycle off the dry heat element 10 when the steam generator 12 requires power to generate steam and to turn the dry heat element 10 back on when the steam generator 12 has cycled off and steam is being introduced into the chamber of the oven 1. This method of energy sharing maintains the total power requirement within regulatory limits, such as UL limits.

The dry heat element 10 provides radiant heat to aid in browning certain types of foods during cooking, a feature not attainable with steam cooking, and it contributes additional heat to that generated by the steam. This combination of steam, radiant and convective heat transfer produces faster cook times than these methods used separately.

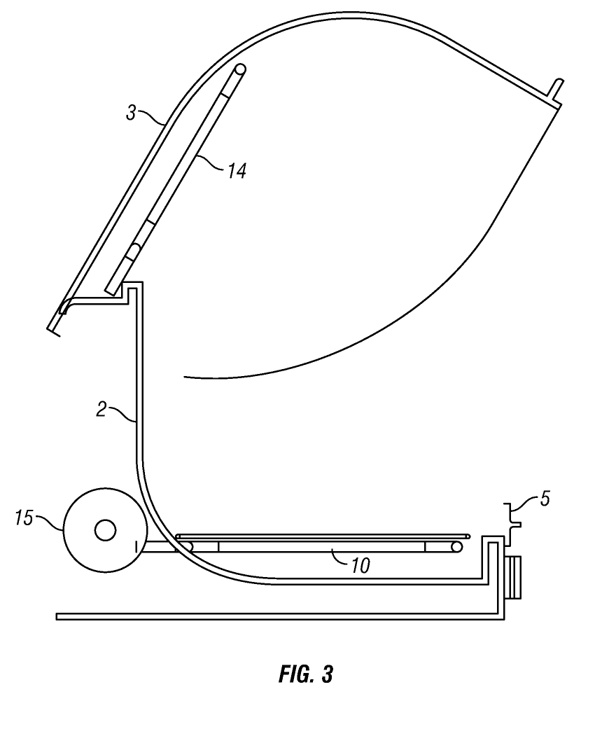

A water tank 13 is provided to store water that a user adds and which, during operation, is converted to steam. Optionally, as shown in FIG. 3, a second dry heat element 14 may be positioned in the cover 3, adapted to pivot therewith during opening, to provide heat from above. A steam pump 15 may be included and used to enhance delivery of the steam generated by the steam generator 12 to an outlet manifold 16. The manifold 16 has one or more openings in it to emit steam. The manifold 16 may be mounted within the cover 3 and adapted to move with it as the cover is opened and closed. The steam may be generated and released continuously or intermittently.

While the preferred embodiment of the present invention has been disclosed herein, it is understood that various modification can be made without departing from the scope of the presently claimed invention.

What is claimed is:

1. An oven for cooking foods, said oven comprising
dry heat generating components;
steam generating components; and
controls for controlling operation of either of said dry heat generating components and said steam generating components separately or together, so that either of said dry heat generating components and said steam generating components may be operated alone or simultaneously with the other.

2. An oven according to claim 1, further comprising
a housing body having an open space therein to receive food products to be cooked and adapted to contain said dry heat generating components and said steam generating components;
a lid pivotally connected to said housing body; and
a water reservoir to receive water for conversion to steam by said steam generating components.

3. A method of cooking food, said method comprising
placing food to be cooked in a chamber;
applying dry heat to said food; and
applying steam to said food simultaneously while applying dry heat.

4. A method according to claim 3, further comprising
selectively initiating application of one of said dry heat or said steam before or after initiating application of the other such that they do not initiate at the same moment in time.

5. A method according to claim 3, further comprising
selectively terminating application of one of said dry heat or said steam before or after terminating application of the other such that they do not terminate at the same moment in time.

6. A method according to claim 3, further comprising
independently and sequentially operating one of said dry heat and said steam so that they are not operated simultaneously.
